(19) United States
(12) Patent Application Publication
(10) Pub. No.: US 2026/0364621 A1
(43) Pub. Date: Nov. 19, 2026

(54) ADJUSTABLE-RELEASE CONTAINER CAPSULE SYSTEM WITH SILICA SCAFFOLD

(71) Applicant: ENVIRONMENTAL SUSTAINABILITY GUARDIAN LIMITED, HONG KONG (CN)

(72) Inventors: KA HO CHENG, HONG KONG (CN); MALVIN SUBROTO PAMUDJI, HONG KONG (CN); YIHE WU, HONG KONG (CN)

(21) Appl. No.: 19/675,549

(22) Filed: May 13, 2026

Related U.S. Application Data
(60) Provisional application No. 63/805,510, filed on May 14, 2025.

(51) Int. Cl. B05B 11/00; B65D 81/32

(52) U.S. Cl. CPC B05B 11/0081; B65D 81/32

(57) ABSTRACT

An adjustable-release container capsule system with a silica scaffold is provided, including a bottle body. Two chambers connected with each other are provided in the bottle body. A capsule compartment is arranged inside one chamber, and a pressure pump assembly is arranged inside the other chamber. A silica scaffold configured to: encapsulate hygienic active ingredients and implement first rapid release and then sustained slow release is arranged inside the capsule compartment. Through a waterproof locking mechanism between the capsule compartment and the supporting frame, a device can quickly switch between an activated state and an inactivated state. In the activated state, the internal space of the capsule compartment contacts a liquid medium to dilute and release the concentrated liquid. In the inactivated state, the internal space is sealed off from the liquid medium in the other chamber, allowing ingredients to diffuse into the isolated water diluent.

### TECHNICAL FIELD

The present disclosure relates to the technical field of hygiene care, and specifically, to an adjustable-release container capsule system with a silica scaffold.

### BACKGROUND

In the fields of hygiene care, personal care, and liquid functional products, the loading and release control of active ingredients are key technical directions for related products. To meet demands for ingredient supply in various usage scenarios, the industry has developed various active ingredient loading containers and release structures, to adapt to the storage, transportation, and ingredient release applications of diverse liquid media.

With the diversified development of application scenarios, there is a growing demand for adjustability of release timing and release rate of active ingredients. Traditional liquid hygiene products, such as hand sanitizer and a disinfectant, typically contain 70% to 80% of water. A high water content will significantly increase the volume of the product, the transportation weight, and single-use plastic waste. To further optimize the management of ingredient release and enhance the flexibility and long-term effectiveness of use of a system, it is necessary to provide a new container capsule system capable of achieving switching between sealed isolation and on-demand activation and adapting to a gradient release function to better meet diverse usage needs.

### SUMMARY

The present disclosure provides an adjustable-release container capsule system with a silica scaffold, to implement controlled mechanical start and stop and gradient chemical release of hygiene active ingredients.

To achieve the foregoing objectives, an adjustable-release container capsule system with a silica scaffold provided in the present disclosure includes a bottle body. Two chambers connected with each other are provided in the bottle body. A capsule compartment is arranged inside one chamber, and a pressure pump assembly is arranged inside the other chamber.

A silica scaffold configured to: encapsulate hygienic active ingredients and implement first rapid release and then sustained slow release is arranged inside the capsule compartment. A supporting frame for supporting the capsule compartment is arranged inside the bottle body. A waterproof locking mechanism is arranged between the capsule compartment and the supporting frame. The waterproof locking mechanism has two usage states: an activated state and an inactivated state.

In the inactivated state, an internal space of the capsule compartment is sealed off from the chambers through the waterproof locking mechanism, and silica scaffold inside the capsule compartment transform the liquid medium reserved inside the capsule compartment into pre-concentrated liquid

In the activated state, the internal space of the capsule compartment is connected with interiors of the chambers through the waterproof locking mechanism, to implement dilution and release of the concentrated liquid inside the chambers.

In some specific embodiments provided in the present disclosure, the capsule compartment is provided with a first water inlet, and the supporting frame is provided with a second water inlet.

The waterproof locking mechanism is in the activated state through alignment and connection between the first water inlet and the second water inlet.

The waterproof locking mechanism is in the inactivated state through misalignment and sealing between the first water inlet and the second water inlet.

In some specific embodiments provided in the present disclosure, the waterproof locking mechanism adopts a rotary valve mechanism.

A capsule compartment cover is rotated to drive the capsule compartment to rotate, so that the first water inlet and the second water inlet are aligned or misaligned, to implement switching between the activated state and the inactivated state.

In some specific embodiments provided in the present disclosure, the rotary valve mechanism completes the switching between the activated state and the inactivated state by 90-degree rotation.

In some specific embodiments provided in the present disclosure, a fastening cover for axially limiting and fixing the capsule compartment and the supporting frame is arranged at a bottle opening of the bottle body.

In some specific embodiments provided in the present disclosure, a second sealing ring is arranged between the supporting frame and the bottle body.

In some specific embodiments provided in the present disclosure, an opening is formed in the bottom of the bottle body. The capsule compartment and a supporting frame are arranged at the opening in the bottom of the bottle body. The capsule compartment cover is rotatably sleeved on the outer side of the bottom of the bottle body. The first water inlet is formed in the top of the capsule compartment, and the second water inlet is formed in the upper part of the supporting frame. The capsule compartment and the supporting frame are in nested threaded connection with each other. When the capsule compartment is rotated by threads through the supporting frame, the first water inlet and the supporting frame undergo axial misalignment displacement, and the first water inlet and the second water inlet are connected with each other.

In some specific embodiments provided in the present disclosure, the waterproof locking mechanism adopts a vertical sliding mechanism.

By pulling the capsule compartment upward, the first water inlet and the second water inlet are aligned and connected.

By pushing the capsule compartment downward, the first water inlet and the second water inlet are misaligned and sealed.

In some specific embodiments provided in the present disclosure, a lower sealing plug located at bottoms of the chambers is arranged on the supporting frame. The second water inlet is arranged on the lower sealing plug. The first water inlet is arranged on the lower side of the capsule compartment. When the capsule compartment is pushed downward to a lowest position, the lower sealing plug seals the first water inlet on the lower side of the capsule compartment.

In some specific embodiments provided in the present disclosure, a third sealing ring is arranged between the capsule compartment and the supporting frame.

In some specific embodiments provided in the present disclosure, a first sealing ring is arranged between the capsule compartment cover and the capsule compartment.

In some specific embodiments provided in the present disclosure, a net rack for supporting the silica scaffold is arranged at an inner lower part of the capsule compartment.

In some specific embodiments provided in the present disclosure, an outer wall of the capsule compartment and an outer wall of the bottle body are made of transparent materials to observe the remaining amount and usage state of the silica scaffold.

In some specific embodiments provided in the present disclosure, the silica scaffold includes silica, an active disinfectant, and a surfactant.

In some specific embodiments provided in the present disclosure, the silica scaffold is prepared, by a sol-gel process involving a surfactant, into a solid porous material for storing active ingredients.

In some specific embodiments provided in the present disclosure, the active disinfectant uses a quaternary ammonium compound. The active disinfectant includes a quaternary ammonium compound or a phenolic compound. The quaternary ammonium compound includes benzalkonium chloride, and the phenolic compound includes chloroxylenol. The surfactant uses an anionic surfactant, a cationic surfactant, a nonionic surfactant, or an amphoteric surfactant.

In some specific embodiments provided in the present disclosure, the anionic surfactant includes, but is not limited to, sodium laureth sulfate and sodium dodecyl sulfate. The cationic surfactant includes, but is not limited to, benzalkonium chloride and cetyltrimethylammonium bromide. The nonionic surfactant includes, but is not limited to, Pluronic F127. The amphoteric surfactant includes, but is not limited to, cocoamidopropyl betaine.

Beneficial effects:
1. Through the waterproof locking mechanism between the capsule compartment and the supporting frame, in conjunction with alignment and connection or misalignment and sealing between the first water inlet and the second water inlet, a device can quickly switch between the activated state and the inactivated state. In the activated state, the internal space of the capsule compartment is in contact with a liquid medium, to achieve dilution and release of concentrated liquid. In the inactivated state, the internal space of the capsule compartment is sealed off from the liquid medium, and the silica scaffold inside the capsule compartment transform the liquid medium reserved inside the capsule compartment into concentrated liquid, thereby implementing reusability and ensuring that the volume of ingredients released per use is substantially the same.
2. When the waterproof locking mechanism is not activated, a fixed amount of isolated liquid medium is reserved in the capsule compartment to ensure continuous contact with the silica scaffold. Active ingredients in the silica scaffold are slowly diffused and reach a concentration equilibrium in a confined space of the capsule compartment, thus forming stable concentrated liquid. This can avoid excessive release of the active ingredients and ensure a stable usage effect during each use.
3. After a user operates the waterproof locking mechanism, the isolation state is relieved, and the concentrated liquid that has completed dissolution equilibrium in advance is quickly released and mixed with a liquid diluent in the main container, thus forming a standard ready-to-use hygienic solution in real time. This structure divides a slow chemical diffusion and rapid release process into two stages, thereby solving the problem of delayed solid tablet feeding and allowing for quick preparation of ready-to-use hygienic solutions at any time.
4. By adopting a two-chamber separated design, it is not necessary to load and transport a large amount of water in advance, thereby significantly reducing the volume and transportation costs of a product and disposable plastic wastes, and achieving reusability and lightweight.
5. By two-layer control of mechanical connection and disconnection, and chemical slow release, macroscopically, valves control the contact timing, and microscopically, porous silica capsule controls a release rate. The dual safeguard ensures stable release, zero leakage, and no risk of sudden and excessive release.

### BRIEF DESCRIPTION OF THE DRAWINGS

To describe the technical solutions in the embodiments of the present disclosure or in the related art more clearly, the following briefly introduces the accompanying drawings for describing the embodiments or the related art. Apparently, the accompanying drawings in the following description show merely some of the embodiments of the present disclosure, and a person of ordinary skill in the art may still derive other drawings from the accompanying drawings without creative efforts.

FIG. 1 is a schematic diagram of a structure according to Embodiment I according to the present disclosure;

FIG. 2 is a partially enlarged view of part A in FIG. 1 according to the present disclosure;

FIG. 3 is a partially enlarged view of part A in FIG. 1 according to the present disclosure;

FIG. 4 is a schematic diagram of a structure according to Embodiment II according to the present disclosure;

FIG. 5 is a partially enlarged view of part C in FIG. 4 according to the present disclosure;

FIG. 6 is a partially enlarged view of part A in FIG. 1 according to the present disclosure;

FIG. 7 is a schematic diagram of a structure according to Embodiment II according to the present disclosure;

FIG. 8 is a partially enlarged view of part C in FIG. 4 according to the present disclosure;

FIG. 9 is a Fourier transform infrared (FTIR) spectroscopy result of ingredients released by a silica scaffold after three-day contact and first/second/third dilution;

FIG. 10 is a UV-Vis absorption result of an active ingredient (sample 1-chloroxylenol) released by a silica scaffold after first/second/third dilution at different contact time points;

FIG. 11 is concentration result of an active ingredient (sample 1-chloroxylenol) released by a silica scaffold at different contact time points;

FIG. 12 is a UV-Vis absorption result of an active ingredient (sample 2-benzalkonium chloride) released by a silica scaffold after first/second/third dilution at different contact time points;

FIG. 13 is concentration result of an active ingredient (sample 2-benzalkonium chloride) released by a silica scaffold at different contact time points;

FIG. 14 is a UV-Vis absorption result of an active ingredient (sample 3-benzalkonium chloride) released by a silica scaffold after first/second/third dilution at different contact time points; and

FIG. 15 is concentration result of an active ingredient (sample 3-benzalkonium chloride) released by a silica scaffold at different contact time points.

Reference numerals in the accompanying drawings are as follows: 1: capsule compartment cover; 2: capsule compartment; 201: first water inlet; 3: supporting frame; 301: second water inlet; 302: lower sealing plug; 4: fastening cover; 5: silica scaffold; 6: net rack; 7: bottle body; 701: chamber; 8: first sealing ring; 9: second sealing ring; 10: third sealing ring; 11: soft rubber plug; 12: pressure pump assembly; and 13: bottom plug.

### DETAILED DESCRIPTION OF THE EMBODIMENTS

In order to make the objectives, technical solutions, and advantages of the present disclosure clearer, a detailed description of the technical solutions of the present disclosure will be provided below. Apparently, the described embodiments are merely some embodiments of the present application, rather than all of the embodiments. All other implementations obtained by a person of ordinary skill in the art based on the embodiments of the present disclosure without making creative efforts shall fall within the protection scope of the present disclosure.

Unless otherwise specified, the relative arrangement, numerical expressions, and numerical values of components and steps described in these embodiments do not limit the scope of the present disclosure. Meanwhile, it should be understood that for the convenience of description, the dimensions of each component shown in the accompanying drawings are not drawn according to actual proportional relationships. The techniques, methods, and equipment known to those of ordinary skill in the art may not be discussed in detail, but in appropriate cases, the techniques, methods, and equipment should be considered as part of this specification. In all the examples shown and discussed here, any specific values should be interpreted as merely exemplary, instead of being restrictive. Therefore, other examples of the exemplary embodiments may have different values. It should be noted that similar reference numerals and letters indicate similar items in the following drawings. Therefore, once a certain item is defined in one drawing, it is unnecessary to further discuss it in the subsequent drawings.

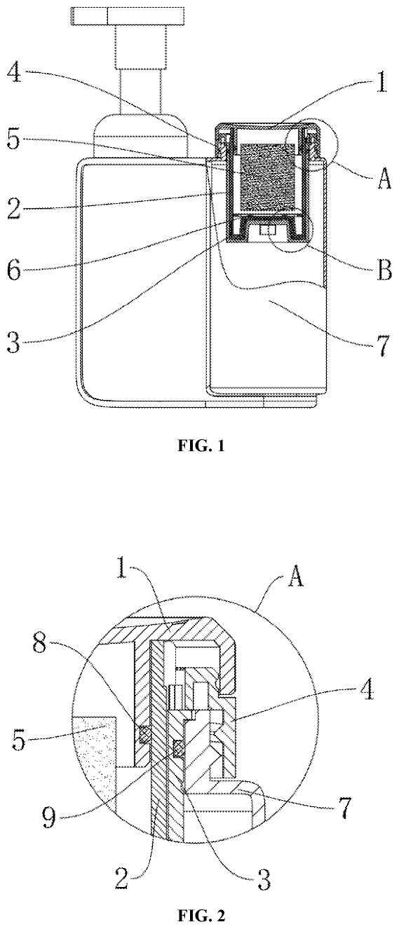

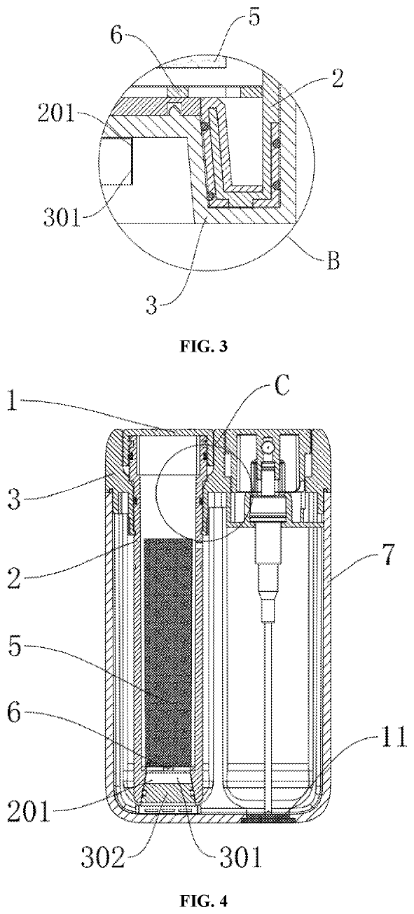

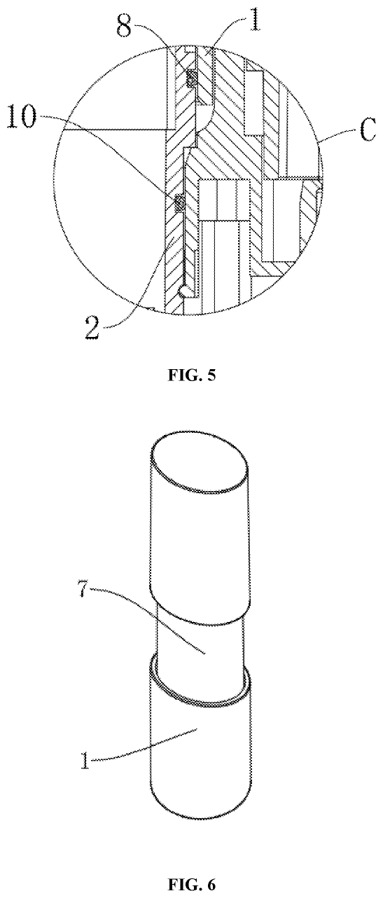

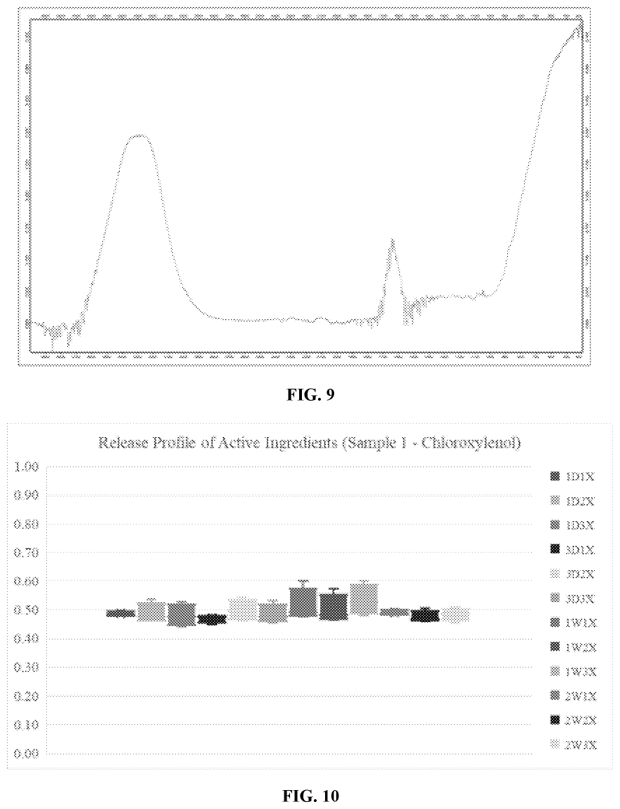

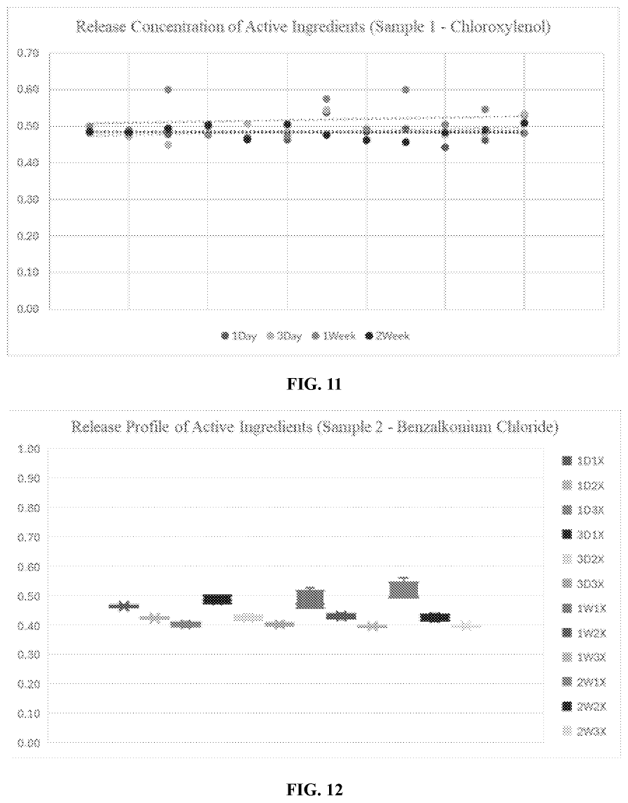

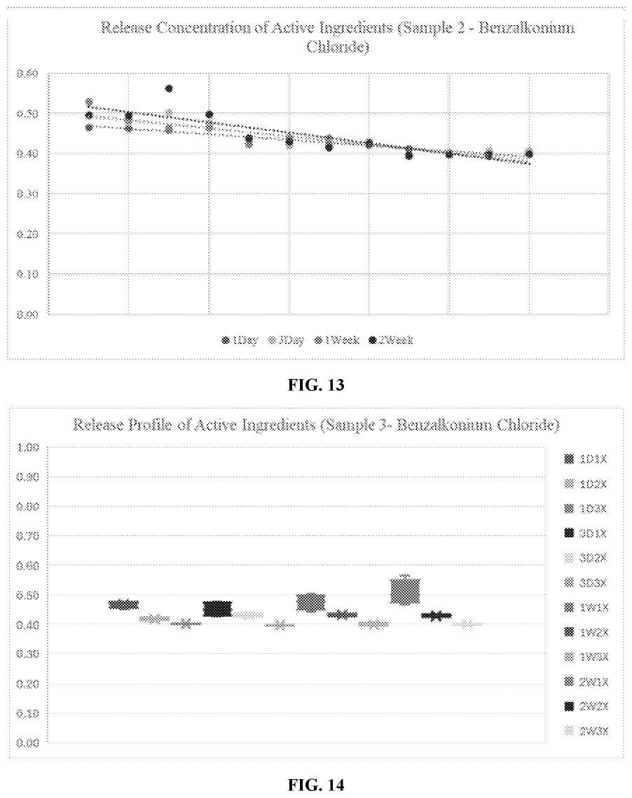

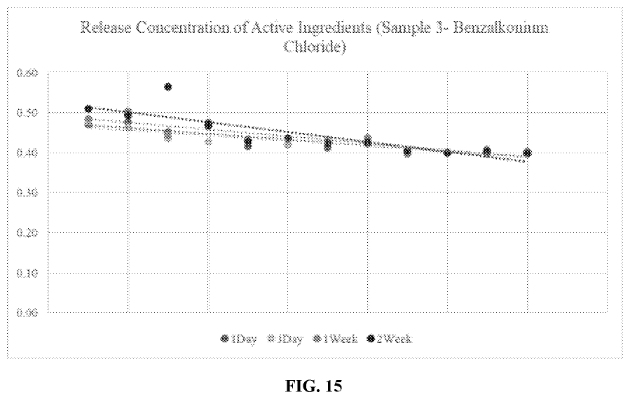

Referring to FIG. 1 to FIG. 12, the present disclosure provides an adjustable-release container capsule system with a silica scaffold, including a bottle body. Two chambers 701 connected with each other are provided in the bottle body, to provide a space for flowing of a liquid medium and release and pumping of active ingredients. A capsule compartment 2 is mounted inside one chamber 701, and a pressure pump assembly 12 is assembled inside the other chamber 701, to provide suction power, to pump out a liquid medium mixed with active ingredients for use.

A silica scaffold 5 configured to: encapsulate hygienic active ingredients and implement first rapid release and then sustained slow release is placed inside the capsule compartment 2.

Meanwhile, a supporting frame 3 for supporting the capsule compartment 2 is also arranged inside the bottle body 7, to provide a fixed mounting foundation and ensure that a relative position between the capsule compartment 2 and the bottle body 7 is stable. To achieve controllability of release of active ingredients, a waterproof locking mechanism is arranged between the capsule compartment 2 and the supporting frame 3. The mechanism has two working states: an activated state and an inactivated state. Details are as follows:

In the inactivated state, an internal space of the capsule compartment 2 is sealed off from the chambers 701 through the waterproof locking mechanism, and the silica scaffold 5 inside the capsule compartment 2 forms the concentrated liquid together with the liquid medium.

In the activated state, the internal space of the capsule compartment 2 is connected with interiors of the chambers 701 through the waterproof locking mechanism, to implement dilution and release of the concentrated liquid inside the chambers 701.

According to the above, by adopting the two-chamber structure, one chamber is configured to accommodate the silica scaffold 5, and the other chamber accommodates the liquid medium. The two chambers are separated by the waterproof locking mechanism, to selectively start or stop the contact between the silica scaffold 5 and the liquid medium. It supports mixing controlled by a user, without packaging and transporting moisture. In addition, multiple repeated activation cycles can be implemented, and ingredients remain basically the same. Furthermore, a user can use the concentrated liquid immediately after the product is activated, without waiting.

To achieve the switching between the foregoing two states, the capsule compartment 2 is provided with a first water inlet 201. The first water inlet 201 is a channel for allowing the liquid medium to enter an interior of the capsule compartment 2. The supporting frame 3 is correspondingly provided with a second water inlet 301. The second water inlet 301 is a channel for allowing the liquid medium to enter an interior of the supporting frame 3 from the chambers 701. The waterproof locking mechanism is in the activated state by relying on the alignment and connection of the first water inlet 201 and the second water inlet 301, and is in the inactivated state through their misalignment and sealing.

When the waterproof locking mechanism is in the inactivated state, an amount of liquid medium will be limited and reserved as a water diluent in the capsule compartment 2, and is completely isolated inside the capsule compartment 2. This physical limitation is crucial. It forces the isolated water diluent to be continuously and locally in contact with the silica scaffold 5. Hygienic active ingredients migrate from the silica scaffold 5 to this limited region. Due to a small and fixed amount of isolated diluent, as the concentration of the active ingredients increases, a diffusion gradient naturally weakens, thereby ultimately reaching a dynamic equilibrium state.

Through this independent cultivation process, a trapped water diluent is transformed into highly effective and chemically stable concentrated liquid. This structural trapping mechanism fundamentally prevents excessive release of the active ingredients, thereby ensuring the quality stability during each release and use.

When operated by a user, the waterproof locking mechanism is opened, thereby breaking a fluid isolation state. The concentrated liquid has undergone the time-consuming diffusion stage during trapping, and is quickly released and uniformly mixed into the liquid medium of a main container body. This immediately transforms a main fluid into a final ready-to-use (RTU) hygiene solution that meets a medical standard. By structurally separating a slow chemical diffusion stage (the first stage) from a rapid delivery stage (the second stage), the capsule chambers overcome the inherent time delay limitation of solid-state chemical delivery, thereby providing an immediate RTU solution for users as required.

### Embodiment I

In this embodiment, the waterproof locking mechanism adopts a rotary valve mechanism. The rotary valve mechanism implements switching between connection and disconnection by rotation.

Specifically, by rotation, the capsule compartment cover 1 and the capsule compartment 2 synchronously rotate, and then the first water inlet 201 and the second water inlet 301 are aligned or misaligned, to complete switching between the activated state and the inactivated state. Specifically, the rotary valve mechanism can achieve state switching by rotating 90 degrees.

To ensure the structural stability, a fastening cover 4 is arranged at a bottle opening of the bottle body 7, to axially limit and fix the capsule compartment 2 and the supporting frame 3, thereby preventing component loosening, detachment, or movement during use.

Meanwhile, to enhance the sealing performance, a second sealing ring 9 is arranged between the supporting frame 3 and the bottle body 7, and a first sealing ring 8 is arranged between the capsule compartment cover 1 and the capsule compartment 2.

In addition, a net rack 6 is arranged at an inner lower part of the capsule compartment 2 to stably support the silica scaffold 5.

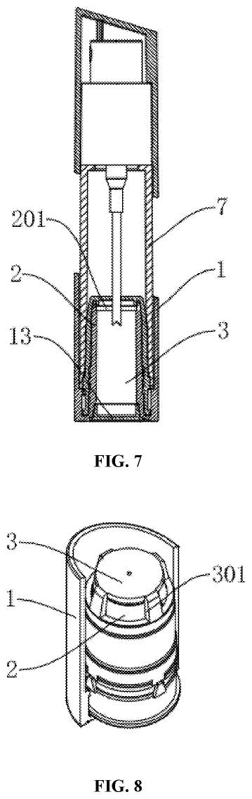

The rotary valve mechanism can also adopt the following structure, as shown in FIG. 6, FIG. 7, and FIG. 8 of this specification. An opening is formed in the bottom of the bottle body 7. The capsule compartment 2 and a supporting frame (3) are arranged at the opening in the bottom of the bottle body 7. The capsule compartment cover 1 is rotatably sleeved on the outer side of the bottom of the bottle body 7. The first water inlet 201 is formed in the top of the capsule compartment 2, and the second water inlet 301 is formed in the upper part of the supporting frame 3. The capsule compartment 2 and the supporting frame 3 are in nested threaded connection with each other. When the capsule compartment 2 is rotated by threads through the supporting frame 3, the first water inlet 201 and the supporting frame 3 undergo axial misalignment displacement, and the first water inlet 201 and the second water inlet 301 are connected with each other.

### Embodiment II

In this embodiment, the waterproof locking mechanism adopts a vertical sliding mechanism.

A specific operation manner is as follows: The capsule compartment 2 is pulled upward to implement alignment and connection between the first water inlet 201 and the second water inlet 301, and the system enters the activated state. The capsule compartment 2 is pushed downward to implement misalignment and sealing between the first water inlet 201 and the second water inlet 301, and the system switches to the inactivated state.

Specifically, the supporting frame 3 is provided with a lower sealing plug 302 located at bottoms of the chambers. The second water inlet 301 is formed in the lower sealing plug 302, and the first water inlet 201 is formed in the lower side of the capsule compartment 2. When the capsule compartment 2 is pushed to a lowest position, the lower sealing plug 302 can directly seal the first water inlet 201, to further block liquid entry.

To prevent liquid leakage during sliding, a third sealing ring 10 is arranged between the capsule compartment 2 and the supporting frame 3, and a first sealing ring 8 is also arranged between the capsule compartment cover 1 and the capsule compartment 2.

Consistent with Embodiment I, the inner lower part of the capsule compartment 2 in this embodiment is also provided with a net rack 6 to support the silica scaffold 5.

An outer wall of the capsule compartment 2 and an outer wall of the bottle body 7 are made of transparent materials to observe the remaining amount and usage state of the silica scaffold 5.

### Embodiment III

In this embodiment, the silica scaffold 5 includes silica, water, an active disinfectant, phenoxyethanol, a surfactant, allura red AC, and an essential oil complex.

The silica scaffold 5 is prepared, by a sol-gel process involving a surfactant, into a solid porous material for storing active ingredients.

The technological preparation method for the silica scaffold is as follows:

### Example 1

Tetraethyl orthosilicate, an acid catalyst, essential oil, active ingredients, and an anionic surfactant, and the like are combined. The tetraethyl orthosilicate is referred to as TEOS, and the silica scaffold is prepared using the TEOS as a primary precursor. In a typical synthesis process, 50 ml of TEOS is hydrolyzed in an acidic aqueous solution (0.1 mol/L hydrochloric acid) at a room temperature while being uniformly stirred. Subsequently, sodium dodecyl sulfate is added into the mixed solution as a surfactant at a concentration exceeding its critical micelle concentration, thereby forming a pore structure template. Then, a disinfectant, essential oil, a preservative, and a dye are added. Finally obtained sol will be gradually transformed into a rigid gel network. Before solidification, this liquid silica scaffold is poured into a cylindrical container to make particles whose weight is approximately 15 g. Fourier transform infrared spectroscopic analysis proves that all organic active ingredients are uniformly encapsulated within the intact silica scaffold. A vibrational frequency of Si—O—Si bonds in the silica scaffold is approximately at 1100 cm⁻¹. This result further proves that both water-soluble active ingredients and lipophilic active ingredients are successfully encapsulated within the silica scaffold.

### Example 2

TEOS, an acid catalyst, essential oil, active ingredients, and a cationic surfactant are combined: 50 ml of TEOS is hydrolyzed in an acidic aqueous solution (0.1 mol/L nitric acid) at a room temperature and reacts under a uniform stirring condition, thereby preparing a silica scaffold. Subsequently, benzalkonium chloride serving as a cationic antibacterial surfactant is added at a concentration exceeding its critical micelle concentrations, thereby simultaneously possessing a pore structure formation template effect and an antibacterial activity. Then, tea tree oil is added as an auxiliary ingredient, and a preservative and a dye are added. An obtained solution is poured into a cylindrical mold for gelation, thereby finally obtaining a granular product whose mass is approximately 15 g. Fourier transform infrared spectroscopic analysis verifies that all organic active ingredients definitely exist in the intact silica scaffold.

### Example 3

TEOS, an acid catalyst, essential oil, active ingredients, and a nonionic surfactant are combined: 50 ml of TEOS is hydrolyzed in an acidic aqueous solution (0.1 mol/L nitric acid) at a room temperature and reacts under a uniform stirring condition, thereby preparing a silica scaffold. PluronicF127 (EO₁₀₆PO₇₀EO₁₀₆) is used as a structure-directing agent for a nonionic triblock copolymer, thereby forming an ordered mesoporous structure. Subsequently, lavender essential oil, a quaternary ammonium compound, a preservative, and a fluorescent whitening agent are added as active ingredients. An obtained solution is cast and aged to finally form a hard gel, thereby finally obtaining cylindrical particles whose weight is 15 g. Fourier transform infrared spectroscopic analysis verifies that all organic active ingredients are uniformly distributed in a silica matrix.

### Example 4

TEOS, an acid catalyst, essential oil, active ingredients, and an amphoteric surfactant are combined: Under an acidic catalytic condition (0.1 mol/L nitric acid), cocoamidopropyl betaine is used as an amphoteric structure-guiding surfactant whose amount exceeds its critical micelle concentration. A silica scaffold is synthesized by using 50 ml of TEOS. In addition, aromatic essential oil, a quaternary ammonium compound, a preservative, and a brightener are also added into the material. An obtained solution is cast into cylindrical particles (about 15 g) which are then aged to form a rigid mesoporous gel. Fourier transform infrared spectroscopy verifies that all organic active ingredients are uniformly distributed in the silica scaffold.

### Example 5

TEOS, an alkaline catalyst, essential oil, active ingredients, and a cationic surfactant are combined: A silica scaffold is prepared by using TEOS as a main precursor. In a typical synthesis process, 50 ml of TEOS is hydrolyzed in an alkaline aqueous solution (0.1 mol/L ammonium hydroxide) under a stirring condition. Cetyltrimethylammonium bromide whose concentration is greater than its critical micelle concentration is added into the mixture as a cationic surfactant, thereby forming a porous structure. Essential oil, a preservative, and an optical brightener are then added. After treatment, the solution will be transformed into a hard gel network. Before solidification, this liquid silica scaffold is poured into a cylindrical particle whose weight is approximately 15 g. Fourier transform infrared spectroscopic analysis verifies that all organic active ingredients definitely exist in the intact silica scaffold.

### Example 6

TMOS, an acidic catalyst, essential oil, active ingredients, and an anionic surfactant are combined: A silica scaffold is prepared by using tetramethyl orthosilicate (TMOS) as a main precursor. 50 ml of tetramethyl orthosilicate (TMOS) is hydrolyzed in an acidic aqueous solution (0.1 mol/L hydrochloric acid). Subsequently, sodium dodecyl sulfate (SDS) is added as an anionic surfactant, and lemon essential oil, a chelating agent, a water softener, a preservative, and a brightener are then added. An obtained solution is cast into cylindrical particles whose weight is 15 g. Since the TMOS releases methanol instead of ethanol during hydrolysis, the particles need to be dried in mild vacuum to remove residual solvents.

### Example 7

TMOS, an alkaline catalyst, essential oil, active ingredients, and an anionic surfactant are combined: 50 ml of TMOS is hydrolyzed in an alkaline aqueous solution (0.1 mol/L ammonium hydroxide, with a pH value of approximately 10) at a room temperature after being uniformly stirred. In a preparation process, sodium dodecyl ether sulfate is first added as an anionic structure-directing agent, and peppermint essential oil, a preservative, and a brightener are then added. Compared with a product prepared by acid catalysis, a product prepared by alkali catalysis has a tighter particle structure and a smaller mesoporous size. Finally obtained particles have a weight of approximate 15 g. The particles are analyzed by Fourier transform infrared spectroscopy: Si—O—Si bond absorption peaks appear in band 1000-1100 cm⁻¹ of a spectrum. C—O—C bond absorption peaks from an ethoxylated chain are located at around 1100 cm⁻¹. S═O bond absorption peaks of sulfate ions are located between 1200-1250 cm⁻¹

The active disinfectant comprises a quaternary ammonium compound or a phenolic compound; and the quaternary ammonium compound includes benzalkonium chloride, and the phenolic compound includes chloroxylenol. An essential oil compound includes frankincense essential oil, sandalwood essential oil, cedar essential oil, chamomile essential oil, and lavender essential oil.

An anionic surfactant, a cationic surfactant, a nonionic surfactant, or an amphoteric surfactant are used.

The anionic surfactant includes, but is not limited to, sodium laureth sulfate and sodium dodecyl sulfate. The cationic surfactant includes, but is not limited to, benzalkonium chloride and cetyltrimethylammonium bromide. The nonionic surfactant includes, but is not limited to, Pluronic F127. The amphoteric surfactant includes, but is not limited to, cocoamidopropyl betaine.

Table of ingredients of the silica scaffold:

| | | Weight | |
|---|---|---|---|
| | Weight | percentage | |
| Ingredients | (g) | (%) | |
| Silica | 1.11 | 19.94% | 7631-86-9 |
| Water | 2.07 | 37.19% | 7732-18-5 |
| Benzalkonium chloride | 0.036 | 0.65% | 63449-41-2 |
| Frankincense essential oil | 0.25 | 4.49% | 8050-07-5 |
| Sandalwood essential oil | 0.25 | 4.49% | 8006-87-9 |
| Cedar essential oil | 0.25 | 4.49% | 8000-27-9 |
| Chamomile essential oil | 0.25 | 4.49% | 8002-66-2 |
| Lavender essential oil | 0.5 | 8.98% | 8000-28-0 |
| Phenoxyethanol | 0.02 | 0.36% | 122-99-6 |
| Sodium lauroyl sarcosinate | 0.58 | 10.42% | 137-16-6 |
| Allura red AC | 0.25 | 4.49% | 25956-17-6 |

The silica scaffold can support multiple activation cycles for 3 to 5 times. During testing, the silica scaffold is in contact with a water diluent in the capsule compartment for set duration of 1 day, 3 days, 1 week, and 2 weeks.

Short term contact (1 day, 3 days): Evaluate the ability of a matrix to rapidly release active ingredients as needed and prepare a final disinfectant, and test the first, second, and third activation cycles.

Long term soaking (1 week, 2 weeks): Simulate long term contact with the diluent, evaluate the structural integrity of the matrix, and verify that the scaffold can prevent excessive or one-time release of active ingredients.

A tested silica scaffold formula includes: silica, water, benzalkonium chloride, phenoxyethanol, sodium lauroyl sarcosinate, allura red AC, frankincense, sandalwood, cedar, chamomile, and lavender.

FTIR spectroscopy is used to analyze organic matters and active ingredients in “concentrated liquid” under different dilution cycles and at contact time points.

Table of reference absorbancy values of ingredients in a silica scaffold

| Wave number | | |
|---|---|---|
| (cm⁻¹) | Functional group | Related ingredients |
| ~3400 (Broad) | O—H stretching vibration | Water and silica |
| 2950-2850 | C—H stretching vibration | Essential oil, sodium |
| | | lauroyl sarcosinate |
| ~1735/~1710 | C═O stretching vibration | Essential oil |
| ~1610/~1510 | Aromatic carboxylate C═C | Benzalkonium chloride, |
| | | benzethonium chloride, |
| | | alcohol, sodium lauroyl |
| | | sarcosinate |
| ~1455/~1375 | C—H bending vibration | All organic ingredients |
| ~1100 (Strong) | Si—O—Si stretching | Silica |
| | vibration | |

The spectrum of non-diluted concentrated liquid proves that the following ingredients have significant signals:
1. The silica scaffold (~1100 cm⁻¹): The asymmetric stretching vibration characteristic peak of Si—O—Si proves the existence of a silica capsule structure.
2. Benzalkonium chloride and phenoxyethanol aromatic rings (~1600 cm⁻¹ peak, ~1510 cm⁻¹ peak, ~830-700 cm⁻¹ peak): They correspond to C—C aromatic ring vibration. Benzalkonium chloride contains benzyl groups; and phenoxyethanol contains aromatic ethers. With reference to the C═O peaks of the essential oil, it proves that the essential oil is co-encapsulated with aromatic preservatives/active ingredients.
3. Essential oil esters/ketones (~1735 cm⁻¹, ~1710 cm⁻¹): With reference to C—O stretching corresponding to esters and ketone, essential oil are rich in esters (such as lavandulyl acetate eugenolate) and ketones, which are key biomarkers for the existence of an essential oil compound. Strong C—H stretching (alkyl chains) at 2950-2850 cm⁻¹ and C—H bending at ~1455 cm⁻¹ and ~1375 cm⁻¹ prove hydrocarbon characteristics of the essential oil.
4. Sodium lauroyl sarcosinate/surfactant (~1610 cm⁻¹, ~1400 cm⁻¹): ~1610 cm⁻¹ overlaps the aromatic ring stretching peak, while a broad peak at ~1400 cm⁻¹ corresponds to carboxylate stretching of the surfactant. The surfactant can stabilize an emulsion or a capsule dispersion solution.

Spectral features of the first, second, and third activations are identical. Peak ratios (e.g. a ratio of a silica peak at ~1100 cm⁻¹ to the essential oil/C—O peak at ~1735 cm⁻¹) are highly stable. It indicates that the encapsulation efficiency and release behaviors are reproducible in multiple user activations.

For samples diluted for the third time at contact time points of 1 day, 3 days, 1 week, and 2 weeks, spectral shapes and relative band intensities are highly consistent with no missing bands. It proves that the formula is degraded after being soaked in water for 14 days. The peaks of all the samples are consistent (the wave number shift <2 cm⁻¹, within an instrument tolerance).

Relative peak ratios are stable: a ratio of the aromatic peak at ~1600 cm⁻¹ to the silica peak at ~1100 cm⁻¹ is approximately 0.35, and a ratio of the carbonyl peak at ~1735 cm⁻¹ to the aliphatic C—H peak at ~2925 cm⁻¹ is approximately 0.40 to 0.42.

A dilution factor does not affect testing. The spectrum mainly shows the wall of the silica scaffold and the water, and organic ingredients can be clearly observed.

The foregoing reference absorbancy values are used for comparing and determining the existence of the ingredients in the diluted concentrated liquid.

To verify the practical application value of the system, an antibacterial contact killing test is carried out on the final mixed solution, and the results are shown in the table below. Antibacterial test results of concentrated diluent released from the silica capsule:

| | | | Logarithmic | Killing | |
|---|---|---|---|---|---|
| Soaking | | | reduction value | rate | |
| time | | Tested strains | (Log10) | (%) | Result |
| 1 | day | Escherichia coli | >3.0 | >99.9% | Pass |
| | | Staphylococcus aureus | >3.0 | >99.9% | Pass |
| 3 | days | Escherichia coli | >3.0 | >99.9% | Pass |
| | | Staphylococcus aureus | >3.0 | >99.9% | Pass |
| 1 | week | Escherichia coli | >3.1 | >99.9% | Pass |
| | | Staphylococcus aureus | >3.0 | >99.9% | Pass |
| 2 | weeks | Escherichia coli | >3.2 | >99.9% | Pass |
| | | Staphylococcus aureus | >3.1 | >99.9% | Pass |

Tested strains: Escherichia coli (Gram negative), and Staphylococcus aureus (Gram positive), with a microbial load of approximately 10⁵ to 10⁶ CFU/mL. The test verifies its effectiveness. The 1-week and 2-week contact experiments mainly find that a release curve is stable. If the formula of the silica scaffold is not consistent, long term soaking will cause the concentration index of the active ingredients to dramatically rise, thereby forming toxic or high-concentration liquid, and there will be no active ingredients in subsequent cycles.

FTIR and UV-Vis data prove that the concentration of the benzalkonium chloride and the concentration of the essential oil reach a functional equilibrium. Even if it is in contact with the liquid for 14 days, the scaffold can still retain reserve ingredients within the porous structure for use in the second, third, and fourth activation cycles.

Low molecular weight active ingredients (such as chloroxylenol) are suitable for multi-cycle continuously stable moderate disinfection scenarios.

High molecular weight active ingredients (such as benzalkonium chloride) are suitable for high-intensity instant disinfection. First rapid release of these ingredients achieves strong sterilization, and then these ingredients are gradually released steadily thereafter. In summary, it should be noted that the present disclosure provides the adjustable-release container capsule system with the silica scaffold, which combines a mechanical control structure with a chemical slow-release carrier to achieve controllable start and stop and gradient release of hygienic ingredients through a physical connection-disconnection adjustment mechanism and slow-release characteristics of materials. This enhances the sealing stability, operation convenience, and reusability performance of the container capsule system, and meets usage needs of efficient loading, precise adjustment, and long-term effect of active ingredients in diverse scenarios.

What is claimed is:

1. An adjustable-release container capsule system with a silica scaffold, comprising a bottle body (7), wherein two chambers (701) connected with each other are provided in the bottle body (7); a capsule compartment (2) is arranged inside one chamber (701), and a pressure pump assembly (12) is arranged inside the other chamber (701);
a silica scaffold (5) configured to: encapsulate hygienic active ingredients and implement first rapid release and then sustained slow release is arranged inside the capsule compartment (2); a supporting frame (3) for supporting the capsule compartment (2) is arranged inside the bottle body (7); a waterproof locking mechanism is arranged between the capsule compartment (2) and the supporting frame (3); the waterproof locking mechanism has two usage states: an activated state and an inactivated state;
in the inactivated state, an internal space of the capsule compartment (2) is sealed off from the chambers (701) through the waterproof locking mechanism, and the silica scaffold (5) inside the capsule compartment (2) forms concentrated liquid together with a liquid medium reserved in the capsule compartment (2); and
in the activated state, the internal space of the capsule compartment (2) is connected with interiors of the chambers (701) through the waterproof locking mechanism, to implement dilution and release of the concentrated liquid inside the chambers (701).

2. The adjustable-release container capsule system with the silica scaffold according to claim 1, wherein the capsule compartment (2) is provided with a first water inlet (201); the supporting frame (3) is provided with a second water inlet (301);
the waterproof locking mechanism is in the activated state through alignment and connection between the first water inlet (201) and the second water inlet (301); and
the waterproof locking mechanism is in the inactivated state through misalignment and sealing between the first water inlet (201) and the second water inlet (301).

3. The adjustable-release container capsule system with the silica scaffold according to claim 2, wherein the waterproof locking mechanism adopts a rotary valve mechanism; and
a capsule compartment cover (1) is rotated to drive the capsule compartment (2) to rotate, so that the first water inlet (201) and the second water inlet (301) are aligned or misaligned, to implement switching between the activated state and the inactivated state.

4. The adjustable-release container capsule system with the silica scaffold according to claim 3, wherein the rotary valve mechanism completes the switching between the activated state and the inactivated state by 90-degree rotation.

5. The adjustable-release container capsule system with the silica scaffold according to claim 3 wherein a fastening cover (4) for axially limiting and fixing the capsule compartment (2) and the supporting frame (3) is arranged at a bottle opening of the bottle body (7).

6. The adjustable-release container capsule system with the silica scaffold according to claim 3, wherein a second sealing ring (9) is arranged between the supporting frame (3) and the bottle body (7).

7. The adjustable-release container capsule system with the silica scaffold according to claim 3, wherein an opening is formed in the bottom of the bottle body (7); the capsule compartment (2) and a supporting frame (3) are arranged at the opening in the bottom of the bottle body (7); the capsule compartment cover (1) is rotatably sleeved on the outer side of the bottom of the bottle body (7); the first water inlet (201) is formed in the top of the capsule compartment (2), and the second water inlet (301) is formed in the upper part of the supporting frame (3); the capsule compartment (2) and the supporting frame (3) are in nested threaded connection with each other; and when the capsule compartment (2) is rotated by threads through the supporting frame (3), the first water inlet (201) and the supporting frame (3) undergo axial misalignment displacement, and the first water inlet (201) and the second water inlet (301) are connected with each other.

8. The adjustable-release container capsule system with the silica scaffold according to claim 2, wherein the waterproof locking mechanism adopts a vertical sliding mechanism;
by pulling the capsule compartment (2) upward, the first water inlet (201) and the second water inlet (301) are aligned and connected;
by pushing the capsule compartment (2) downward, the first water inlet (201) and the second water inlet (301) are misaligned and sealed.

9. The adjustable-release container capsule system with the silica scaffold according to claim 8, wherein a lower sealing plug (302) located at bottoms of the chambers is arranged on the supporting frame (3); the second water inlet (301) is arranged on the lower sealing plug (302); the first water inlet (201) is arranged on a lower side of the capsule compartment (2); and when the capsule compartment (2) is pushed downward to a lowest position, the lower sealing plug (302) seals the first water inlet (201) on the lower side of the capsule compartment (2).

10. The adjustable-release container capsule system with the silica scaffold according to claim 8, wherein a third sealing ring (10) is arranged between the capsule compartment (2) and the supporting frame (3).

11. The adjustable-release container capsule system with the silica scaffold according to claim 3, wherein a first sealing ring (8) is arranged between the capsule compartment cover (1) and the capsule compartment (2).

12. The adjustable-release container capsule system with the silica scaffold according to claim 3, wherein a net rack (6) for supporting the silica scaffold (5) is arranged at an inner lower part of the capsule compartment (2).

13. The adjustable-release container capsule system with the silica scaffold according to claim 3, wherein an outer wall of the capsule compartment (2) and an outer wall of the bottle body (7) are made of transparent materials to observe a remaining amount and usage state of the silica scaffold (5).

14. The adjustable-release container capsule system with the silica scaffold according to claim 3, wherein the silica scaffold (5) comprises silica, an active disinfectant, and a surfactant.

15. The adjustable-release container capsule system with the silica scaffold according to claim 14, wherein the silica scaffold (5) is prepared, by a sol-gel process involving a surfactant, into a solid porous material for storing active ingredients.

16. The adjustable-release container capsule system with the silica scaffold according to claim 14, wherein the active disinfectant comprises a quaternary ammonium compound or a phenolic compound; the quaternary ammonium compound includes benzalkonium chloride, and the phenolic compound includes chloroxylenol; and the surfactant uses an anionic surfactant, a cationic surfactant, a nonionic surfactant, or an amphoteric surfactant.

17. The adjustable-release container capsule system with the silica scaffold according to claim 16, wherein the anionic surfactant comprises, but is not limited to, sodium laureth sulfate and sodium dodecyl sulfate; the cationic surfactant comprises, but is not limited to, benzalkonium chloride and cetyltrimethylammonium bromide; the nonionic surfactant comprises, but is not limited to, Pluronic F127; and the amphoteric surfactant comprises, but is not limited to, cocoamidopropyl betaine.
